(19) United States
(12) Patent Application Publication
(10) Pub. No.: US 2009/0018241 A1
(43) Pub. Date: Jan. 15, 2009

(54) HALOGEN-FREE PHOSPHOROUS EPOXY RESIN COMPOSITION

(76) Inventors: Yu Hsain Cheng, Hsinchu City (TW); We Ming Te, Hsinchu County (TW)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/162,610

(22) PCT Filed: Feb. 22, 2007
(86) PCT No.: PCT/US07/04853

§ 371 Date: Jul. 30, 2008

(30) Foreign Application Priority Data
Feb. 23, 2006 (TW) 95106032

(51) Int. Cl. C08K 5/3492; C08G 8/04; C08K 3/32; C08K 3/38; C08K 3/36

(52) U.S. Cl. 524/100; 524/512; 524/509; 524/416; 524/508; 524/539; 524/436; 524/456; 524/404

(57) ABSTRACT

The present invention relates to a halogen-free phosphorous epoxy resin composition, primarily used as an adhesive for the printed circuit board. The composition comprises a halogen-free phosphorous contained epoxy resin which reduces the addition amount of additional flame retardant; in order to offer flame retardancy while maintaining high flexibility of flexible printed circuit board.

### FIELD OF INVENTION

The present invention relates to a halogen-free phosphorous epoxy resin composition. Specifically, it relates to a halogen-free phosphorous epoxy resin composition applicable to the flexible printed circuit board.

### BACKGROUND OF THE INVENTION

The flexible printed circuit board is the very foundation for all electronic products. To go along with the global trend of environmental protection, for example, the European Union Restriction of Hazardous Substance restricted two types of flame retardants containing bromine used for electric and electronic products. Namely, no more than 0.1% polybromided biphenyls (PBB), polybromided diphenylethers (PBDE) and the same category materials are allowed. In addition, the standards in Japan are even stricter, that the total halogen content in the substance must be less than 1600 ppm. These standards imply that the conventional halogen-containing flame retardant can no longer continuously be used in the flexible printed circuit board in the current market. Therefore, the halogen-free materials are becoming key development projects for manufacturers.

The Flexible Printing Circuit (FPC, which also called as flexible board in short) is a printed circuit board made with a flexible substrate, which has been widely used for electronic products such as notebooks, cellular phones, liquid crystal displays, and cameras because of its flexibility, three dimensional wiring capability in the limited space and special shape provided, that meets the demand for light in weight, thin, short, and small in size.

The epoxy resin has been used as the adhesive for the flexible circuit boards for long time. In recent years, development of halogen-free materials has gradually become the environmental protection regulation requirement globally, in order to meet the demand for environmental protection. However, the ordinary halogen-free epoxy resin adhesive contains an epoxy resin without flame retardancy, and an additional flame retardant was added to attain flame retardancy effects. Currently, most of the adhesives contain a flame retardant in the components to achieve the flame retardancy. However, in order to pass the electronic material flame retardancy test, a large amount of filler added will reduce the flexibility of the resin solid. For example, the working example of the R.O.C. Patent No. 092003 disclosed a method simply by adding a phosphorous flame retardant combining with other inorganic flame retardants, and the weight part of the addition occupies about 31% of total solid ingredients. In order to solving the environment contaminating problems caused by the halogen-containing materials. The purpose of the present invention is to develop a halogen-free adhesive, that will replace the bromine-containing adhesive used for the printed circuit board, especially the flexible printed circuit board. Since the commercially available halogen-free adhesives commonly added a large amount of anti-flame retardant, in order to attain certain flame retardancy effects, the large amount of flame retardant added leads to negative impact on the flexibility of the final solid material. This will affect the adhesion of the flexible printed circuit board demanding flexibility. Therefore, the present invention focuses on the flexibility of the adhesive used for the flexible circuit board, and attempted to improve the ordinary halogen-free adhesive added with large amount of flame retardant to attain flame retardancy, that causes the degraded flexibility of the product after solidification and formation, and the invention can be used to substitute the original halogen-containing adhesive used for flexible printed circuit board.

### SUMMARY OF THE INVENTION

In order to solve the environment contaminating problems caused by the halogen-containing materials, the purpose of the present invention is to develop a halogen-free adhesive, that can be used to substitute the bromine-containing adhesive used for the printed circuit board, especially the flexible printed circuit board. The adhesive of the present invention must possess high flexibility, low water absorption, lowered resin flow, good reliability and excellent adhesive strength to metals and plastic substrates.

In order to attain the above mentioned purpose, the present invention provides a phosphorous halogen-free composition that comprises:

one part of halogen-free phosphorous epoxy resin;
one part of curing agent;
one part of catalyst;
one part of elastomer;
and one part of filler.

Among them, the above mentioned phosphorus epoxy resin has the structure as shown in the following formula (I)

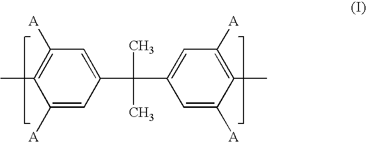

wherein A is

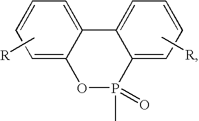

or a hydrogen, or a halogen-free substituted alkyl group, or alkoxy group; R is a hydrogen, halogen-free substituted hydroxyl, alkyl group or alkoxy group.

Said halogen-free resin includes the halogen-free epoxy resin or the halogen-free phenol formaldehyde resin.

Said composition may further contain a silane compound.

After the halogen-free composition of the present invention is coated on a polyimide film and crimped with the copper foil at a high temperature through laminating and pressing under heat, it is provided with the following characteristics: flame retardancy reached the UL94VTM-0 standard, peel strength at 90° is greater than 0.6 kg/cm (IPC TM650 standard), MIT is greater than 800 times (JIS C6471 R=0.38), high temperature proof (Solder float at 260° C., 10 sec; IPC TM650), high temperature and damp proof (at 90° peel strength at 85% RH/85 24 hr is greater than 0.6 kg/cm), and resin flow property is smaller than 250 μm.

The present invention reduces the total weight part of the filler in the composition, since the high content of the filler will lead to poor flexibility, to 15% or lower, to prevent degraded flexibility of the final solid product due to the addition of a large amount of powdery. The halogen-free phosphorous epoxy resin composition of the present invention has high degree of flexibility and can be used as an adhesive for the printed circuit board, especially for the flexible printed circuit board.

### DETAILED DESCRIPTION OF THE INVENTION

The halogen-free phosphorous epoxy resin composition of the present invention comprises a halogen-free phosphorous epoxy resin, a halogen-free resin, a curing agent, a catalyst, an elastomer, and a filler; wherein said phosphorous epoxy resin has the structure as shown in the following formula:

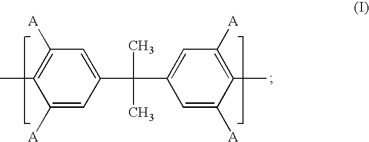

wherein A is

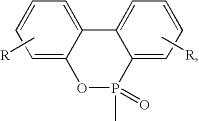

or a hydrogen, or an unsubstituted or halogen-free alkyl group, or alkoxy group; R is a hydrogen, unsubstituted or halogen-free substituted hydroxyl, alkyl group or alkoxy group.

In the preferred embodiment, the halogen-free phosphorous epoxy resin has the structure as shown in the following formula:

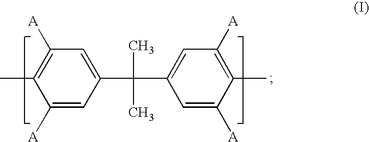

wherein A is

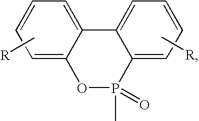

R is a hydrogen (the example given is defined as preferred embodiments, not intended to rank in superiority), then, 9,10-dihydro-9-oxa-10-phosphaphenanthrene-10-oxide DOPO.

The halogen-free resin referred in the present invention includes, but is not limited to halogen-free epoxy resin or halogen-free phenol formaldehyde resin, which are the halogen-free resin components used for the adhesive as well-known by people in the art.

The curing agent stated in the present invention, which is a hardening or solidifying material well-known by people in the art, which includes, but not limited to diaminodiphenyl sulfone (DDS), dicyandiamide (DICY), adipic dihydrazide (ADH), and phenol-novolac resin or mixture thereof. The elastomer stated in the present invention, which is a substance used for providing flexibility as well-known by people in the art, which includes, but not limited to the carboxy terminated butadiene acrylonitrile (CTBN), amine terminated butadiene acrylonitrile (ATBN), polyamide, polyester or mixture thereof.

The catalyst stated in the present invention, which is a substance used for catalyzing the hardening and solidification reaction as is well-known by people in the art, which includes, but not limited to 2-methyl imidazole (2MI), 2-ethyl-4-methyl imidazole (2E4MI), triphenyl phosphate (TPP), or mixture thereof.

The filler stated in the present invention, which is a substance used for providing flame retardancy effect as is well-known by people in the art, which includes, but not limited to the halogen-free flame retardant, inorganic powder, and mixtures thereof. The halogen-free flame retardant includes, but not limited to ammonium polyphosphate (APP), melamine polyphosphate (MPP), melamine cyanurate (MC), melamine Pyrophosphate (MP), or mixture thereof. The inorganic powder includes, but is not limited to Magnesium hydroxide, silica, boron nitride (BN), or mixture thereof.

In a common embodiment, the weight percentage of the components of the composition of the present invention is the following: 5˜50 wt. % halogen-free phosphorous epoxy resin, 5˜50 wt. % halogen-free resin, 5˜20 wt. % curing agent, 0.01˜1 wt. % catalysts, 10˜50 wt. % elastomer, and 5 wt. % or more filler. After the composition is coated on a substrate through laminating and pressing with heat, the following characteristics are obtained: flame retardancy reached the UL94VTM-0 standard, peel strength at 90° is greater than 0.6 kg/cm (IPC TM650 standard), MIT is greater than 1,000 times (JIS C6471 R=0.38), and resin flow property (IPC TM650 2.3.17.1) is under 200 μm.

In a preferred embodiment, the weight percentage of the components of the composition of the present invention is the following: 5˜50 wt. % halogen-free phosphorous epoxy resin, 5˜50 wt. % halogen-free resin, 5˜20 wt. % curing agent, 0.01˜1 wt. % catalysts, 10˜50 wt. % elastomer, and 5 wt. % or more filler. After the composition is coated on a substrate through laminating and pressing with heat, it is provided with the following characteristics: flame retardancy reached the UL94VTM-0 standard, peel strength at 90° is greater than 0.6 kg/cm (IPC TM650 standard), MIT is greater than 1,600 times (JIS C6471 R=0.38), high temperature proof (Solder float at 260° C., 10 sec; IPC TM650), high temperature and humidity resistance (at 90° peel strength at 85% RH/85 24 hr is greater than 0.6 kg/cm), and resin flow property (IPC TM650 2.3.17.1) is under 150 μm.

### EXAMPLES

The following workings examples are provided for further clarify the advantages of the present invention, and it is not intended to limiting the scope of the invention.

### Example 1

A halogen-free phosphorous epoxy resin composition is prepared by dissolving 5 g CTBN and 30 g methyl ethyl ketone (MEK) in a reaction container, stir thoroughly until is completely dissolved, then add 3 g Mg(OH)₂, 0.6 g DDS, and 0.2 g 2E4MI, maintain at normal temperature, stir, and mix homogeneously. Then add 10 g halogen-free epoxy resin and 10 g MEK, stir continuously until reached to a homogeneous dispersed sticky solution state. Thus, a halogen-free epoxy resin composition (containing no phosphorus) is obtained.

Measuring

Coat the aforementioned composition solution on a substrate, the film thickness is ranged between 5˜50 μm, and the substrate could be metal or plastic thin film. The coating on a plastic substrate is baked in an over (the temperature range is between 75° C. to 200° C.) until it is ready to use, a multi-layer composition (b) is obtained. A coverlay for the flexible circuit board is formed after laminating the composition (a) with a film. When the composition (a) is press-fit with a copper foil and allowed for hardening, then a 3-layer product is formed. A back rubber copper foil is formed after laminating the composition (b) with the film.

After the halogen-free composition of the present invention is coated on a substrate at a high temperature through laminating and pressing with heat, it is provided with the following characteristics: flame retardancy reached the UL94VTM-0 standard, peel strength at 90° is greater than 0.6 kg/cm (IPC TM650 standard), MIT is greater than 800 times (JIS C6471 R=0.38), high temperature proof (Solder float at 260° C., 10 sec; IPC TM650), high temperature and humidity resistance (at 90° peel strength at 85% RH/85 24 hr is greater than 0.6 kg/cm), and resin flow property is less than 250μ.

### Example 2

A halogen-free phosphorous epoxy resin composition prepared by dissolving 4 g CTBN and 40 g methyl ethyl ketone (MEK) in a reaction bath, stir thoroughly until is completely dissolved, then add 13 g Mg(OH)₂, 0.9 g DDS, and 0.1 g 2E4MI, maintain at normal temperature, stir, and mix homogeneously. Then add 10 g halogen-free epoxy resin and 10 g MEK, stir continuously until reached to a homogeneous dispersed sticky solution state. Thus, a halogen-free epoxy resin composition (containing no phosphorus) is obtained.

The measuring method is identical with working example 1.

### Example 3

A halogen-free phosphorous epoxy resin composition is prepared by dissolving 5 g CTBN and 30 g methyl ethyl ketone (MEK) in a reaction bath, stir thoroughly until is completely dissolved, then add 1.5 g Mg(OH)₂, 7 g SiO₂, 1 g DDS, and 0.1 g 2E4MI, maintain at normal temperature, stir, and mix homogeneously. Then add 8 g halogen-free phosphorous epoxy resin, 2 g epoxy resin without phosphorous content, and 10 g MEK, stir continuously until reached to a homogeneous dispersed sticky solution state. Thus, a halogen-free phosphorous epoxy resin composition is obtained.

The measuring method is identical with working example 1.

### Example 4

A halogen-free phosphorous epoxy resin composition is prepared by dissolving 5 g CTBN, 6 g polyester, and 30 g methyl ethyl ketone (MEK) in a reaction bath, stir thoroughly until is completely dissolved, then add 5 g MPP (melamine polyphosphate), 1.1 g DDS, and 0.05 g 2E4MI, maintain at normal temperature, stir, and mix homogeneously. Then add 10 g epoxy resin without phosphorous content and 10 g MEK, stir continuously until reached to a homogeneous dispersed sticky solution state. Thus, a halogen-free epoxy resin composition (containing no phosphorus) is obtained.

The measuring method is identical with working example 1.

### Example 5

A halogen-free phosphorous epoxy resin composition is prepared by dissolving 3 g CTBN and 30 g methyl ethyl ketone (MEK) in a reaction bath, stir thoroughly until is completely dissolved, then add 2 g SiO₂, 1 g APP, 2 g Mg(OH)₂, 0.9 g DDS, and 0.121 g 2MI, maintain at normal temperature, stir, and mix homogeneously. Then add 4 g phosphorous epoxy resin, 6 g epoxy resin without phosphorous content, and 10 g MEK, stir continuously until reached to a homogeneous dispersed sticky solution state. Thus, a halogen-free phosphorous epoxy resin composition is obtained and added to the phosphorus-containing flame retardant composition.

The measuring method is identical with working example 1.

### Example 6

A halogen-free phosphorous epoxy resin composition was prepared by dissolving 5 g CTBN and 30 g methyl ethyl ketone (MEK) in a reaction bath, stir thoroughly until is completely dissolved, then add 3 g SiO2, 3 g APP, 4 g Mg(OH)2, 1 g DDS, and 0.093 g 2MI, maintain at normal temperature, stir, and mix homogeneously. Then add 4 g phosphorous epoxy resin, 7 g epoxy resin without phosphorus content, and 10 g MEK, stir continuously until reached to a homogeneous dispersed sticky solution state. Thus, a halogen-free phosphorous epoxy resin composition is obtained and added to the phosphorus-containing flame retardant composition.

The measuring method is identical with working example 1.

### Example 7

A halogen-free phosphorous epoxy resin composition was prepared by dissolving 5 g CTBN and 30 g methyl ethyl ketone (MEK) in a reaction bath, stir thoroughly until is completely dissolved, then add 3 g SiO₂, 3 g APP, 4 g Mg(OH)₂, 1 g DDS, and 0.093 g 2MI, maintain at normal temperature, stir, and mix homogeneously. Then add 4 g phosphorous epoxy resin, 7 g epoxy resin without phosphorous content, and 10 g MEK, stir continuously until reached to a homogeneous dispersed sticky solution state. Thus, a halogen-free phosphorous epoxy resin composition is obtained and added to the phosphorus-containing flame retardant composition.

The measuring method is identical with working example 1.

Various characteristics of the adhesive comprising the composition prepared in the aforementioned working examples were measured. The measured properties include: resin flow (fluidity, preferably <200 μm/25 μm), flame retardancy (preferably pass the UL94VTMO standard), MIT (preferably in compliance with the measurement method according to JIS C6471 R=0.38, MIT>1,000 times), and high temperature resistance (pass soldering float at 288° C., 10 sec.).

TABLE 1

| | Working example | | | | | | |
|---|---|---|---|---|---|---|---|
| | 1 | 2 | 3 | 4 | 5 | 6 | 7 |
| Resin flow (um) | 200 | 200 | 40 | 40 | 70 | 50 | 50 |
| Flame retardancy | NG | VTM0 | VTM0 | VTM0 | VTM0 | VTM0 | VTM0 |
| MIT | 2015 | 1050 | 2466 | 2237 | 3162 | 2231 | 2257 |
| High temperature | Fail | Pass | Pass | Fail | Pass | Pass | Pass |
| resistance | | | | | | | |
| (Soldering float at 288° C., | | | | | | | |
| 10 sec.) | | | | | | | |

It is clear from the results of the working examples that when phosphorus-free epoxy resin was used as in the case of working examples 1 and 2, the resin flow property barely meets the 200 μm requirement, however, further improvement is expected on the flame retardancy properties, MIT, and high temperature resistance properties.

As for the case of working example 4, although a phosphorus flame retardant was used, there are property drawbacks when applied at high temperature. However, the application of the halogen-free phosphorous epoxy resin composition of the present invention (working example 3) displayed superb properties in all aspects of areas, if a phosphorus-containing flame retardant is further combined (working examples 5-7), MIT and other properties including peeling strength can be further enhanced.

In conclusion, the halogen-free phosphorous epoxy resin composition of the present invention can be used as an adhesive for printed circuit board, especially for flexible printed circuit board for its excellent flexibility. The content of halogen-free phosphorous epoxy resin reduces the amount burning-inhibitor additionally added, while maintaining high flexibility and the required flame retardancy properties.

All characteristics disclosed in the specification can be combined with other methods; each of the characteristic disclosed in the present invention can be selectively substituted by the characteristics with identical, equivalent, similar purposes. Therefore, except the particularly obvious characteristics, the characteristics disclosed in the present specification are only one of the examples of the equivalent or similar characteristics.

While the presently preferred embodiment of the present invention has been shown and described, it is to be understood that this disclosure is for the purpose of illustration and that various changes and modifications may be made without departing from the scope of the invention as set forth in the appended claims.

What is claimed is:

1. A type of phosphorus-containing halogen-free epoxy resin composition is used as an adhesive, and the composition comprises:
a part of phosphorus-containing halogen-free epoxy resin composition;
a part of halogen-free resin;
a part of catalyst;
a part of elastomer;
and a part of filler;
Wherein said halogen-free phosphorus epoxy resin has the structure as shown in the following formula (I). 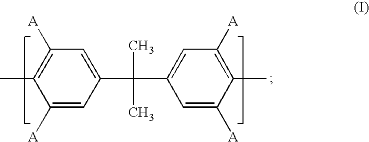
wherein A is 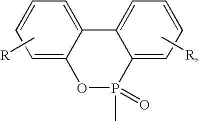
or a hydrogen, or a halogen-free alkyl group, or alkoxy group; R is the hydrogen, halogen-free substituted alkyl group or alkoxy group.

2. A composition of claim 1 comprises:
5˜50 wt % part phosphorus-containing halogen-free epoxy resin;
5˜50 wt % part halogen-free resin;
5˜20 wt % part curing agent;
0.1˜1 wt % part catalyst;
10˜50 wt % part elastomer;
and 5 wt % part or more filler (considering adding an appended preferred ratios).

3. A composition of claim 1, wherein said halogen-free resin is a halogen-free epoxy resin or halogen-free phenol formaldehyde resin.

4. A composition of claim 1, wherein said curing agent includes diaminodiphenyl sulfone (DDS), dicyandiamide (DICY), adipic dihydrazide (ADH), and phenol-aldehyde resin or mixture thereof.

5. A composition of claim 1, wherein said elastomer includes the carboxy terminated butadiene acrylonitrile (CTBN), amine terminated butadiene acrylonitrile (ATBN), polyamine, polyethylene terephthalate or mixture thereof.

6. A composition of claim 1, wherein said 2-methyl imidazole (2MI), 2-ethyl-4-methyl imidazole (2E4MI), triphenyl phosphate (TPP), or mixture thereof.

7. A composition of claim 1, wherein said filler includes a halogen-free flame retardant, inorganic powder, or mixture thereof.

8. A composition of claim 7, wherein said halogen-free flame retardant includes ammonium polyphosphate (APP), melamine polyphosphate (MPP), melamine cyanurate (MC), Melamine Pyrophosphate or mixture thereof.

9. A composition of claim 1, wherein said inorganic powder includes magnesium hydroxide, silica, magnesium silicate hydroxide, boron nitride (BN), or mixture thereof.

10. A composition of claim 1, wherein said composition is used as an adhesive for printed circuit board.

11. A composition of claim 10, wherein said printed circuit board is a flexible printed circuit board.

12. The halogen-free phosphorous epoxy resin composition of the present invention comprises a halogen-free phosphorous epoxy resin, a halogen-free resin, a curing agent, a catalyst, an elastomer, and a filler; wherein said phosphorous epoxy resin has the structure as shown in the following formula:
(I); 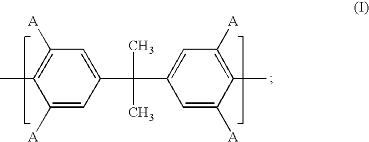
wherein A is 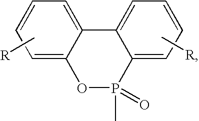
or a hydrogen, or an unsubstituted or halogen-free alkyl group, or alkoxy group; R is a hydrogen, unsubstituted or halogen-free substituted Hydroxyl, alkyl group or alkoxy group; After the halogen-free composition of the present invention is coated on a polyamide film and crimped with the copper foil at a high temperature through laminating and pressing under heat, it is provided with the following characteristics: flame retardancy reached the UL94VTM-0 standard, peel strength at 90° is greater than 0.6 kg/cm (IPC TM650 standard), MIT is greater than 800 times (JIS C6471 R=0.38), high temperature proof (Solder float at 260° C., 10 sec; IPC TM650), high temperature and damp proof (at 90° peel strength at 85% RH/85 24 hr is greater than 0.6 kg/cm), and resin flow property is smaller than 250 μm
